(19) United States
(12) Patent Application Publication
(10) Pub. No.: US 2024/0311865 A1
(43) Pub. Date: Sep. 19, 2024

(54) METHODS, SYSTEMS, ARTICLES OF MANUFACTURE AND APPARATUS TO DETERMINE COMPONENT LIFTS FROM OVERLAPPING STIMULI

(71) Applicant: The Nielsen Company (US), LLC, New York, NY (US)

(72) Inventors: Michael Sheppard, Holland, MI (US); Cermel Ream, Saint Petersburg, FL (US)

(73) Assignee: The Nielsen Company (US), LLC, New York, NY (US)

(21) Appl. No.: 18/675,890

(22) Filed: May 28, 2024

Related U.S. Application Data
(63) Continuation of application No. 16/186,444, filed on Nov. 9, 2018.

(51) Int. Cl. G06Q 30/0242; G06Q 30/0241

(52) U.S. Cl. CPC G06Q 30/0243; G06Q 30/0249

(57) ABSTRACT

Methods, apparatus, systems and articles of manufacture are disclosed to determine component lifts and synergy from overlapping stimuli. An example disclosed apparatus to allocate advertising campaign resources includes a vehicle segregator to segregate impression counts of an advertisement campaign into vehicle types and segregate measured lift values associated with the impression counts into respective ones of the vehicle types, the segregated measured lift values corresponding to respondents that viewed an advertisement corresponding to one of the respective ones of the vehicle types. The example apparatus further includes a correlation engine to establish correlations between the measured lift values and component lift values, the correlations based on a weighted average of the component lift values and segregated impression counts, the component lift values corresponding to respondents that viewed an advertisement corresponding to one of the respective ones of the vehicle types, a lift calculator to determine the component lift values based on the correlations and a campaign selector to modify computing resource allocation to at least one of the vehicle types of the advertising campaign based on a comparison of the determined component lift values.

### RELATED APPLICATION(S)

This patent application is a continuation of U.S. patent application Ser. No. 16/186,444, filed Nov. 9, 2018. U.S. patent application Ser. No. 16/186,444, is incorporated herein by reference in its entirety. Priority to U.S. patent application Ser. No. 16/186,444 is hereby claimed.

### FIELD OF THE DISCLOSURE

This disclosure relates generally to advertising data science, and, more particularly, to methods, systems, articles of manufacture and apparatus to determine component lifts and synergy from overlapping stimuli.

### BACKGROUND

In recent years, advertising campaigns for products have begun using multiple media vehicles to present information to potential customers about the product. The use of multiple vehicles allows customers to be exposed to different vehicles of advertising stimuli (e.g., radio, television, online, etc.). Advertising companies and/or other entities (e.g., audience measurement entities (AMEs), etc.), are often interested in determining the effectiveness of the different vehicles of advertisement campaigns.

### BRIEF DESCRIPTION OF THE DRAWINGS

FIG. 1 is a schematic illustration of an example system to calculate component lifts in accordance with the teachings of this disclosure.

FIG. 2 is an example implementation of the example lift engine of FIG. 1.

FIG. 3 is a flowchart representative of machine readable instructions which may be executed to implement the example lift engine of FIG. 1.

FIG. 4 is a block diagram of an example processing platform structured to execute the example instructions of FIG. 3 to implement the example lift engine of FIG. 1.

The figures are not to scale. In general, the same reference numbers will be used throughout the drawing(s) and accompanying written description to refer to the same or like parts.

### DETAILED DESCRIPTION

Product and service promotional activity can occur on one or more different types of media vehicles. As used herein a “media vehicle,” or more simply, a “vehicle,” refers to a specific type of media (e.g., an advertising creative or stimulus delivered or otherwise exposed to a target audience, etc.) used to deliver advertisements. Example vehicles include radio, newspapers, television, etc. Vehicles can also be defined as groups of other vehicle subsets. For example, the “digital” vehicle can refer to any combination of online advertisements which may be viewed on mobile devices, desktop computers, and/or any other suitable digital devices. An advertising campaign can use one or more vehicles to convey advertisements to a consumer. As used herein, “advertising,” “advertisements,” and/or variants thereof refers to a type of marketing effort in which a product and/or service of interest is communicated through one or more media vehicles. Advertisements can include product and/or service’ information, audio and/or visual information (e.g., a song, a product image, a commercial, etc.) in an effort to expose an audience with such product and/or service information. As used herein, a “consumer,” “consumers,” “an audience,” “an audience member,” refer to respondents (e.g., survey participants), panelists and/or more generally humans that exhibit behavior(s) that are observed in the technical field of market research.

One metric used to measure the effectiveness of an advertisement campaign and/or vehicle is lift. Lift, as used herein, refers to the change in sales of a product associated with an advertising campaign. For example, a positive lift value can be associated with an increase in sales of a product (e.g., increased sales when compared to a baseline metric of sales, etc.), and a negative lift value can be associated with a decrease in sales of the product (e.g., a person may be deterred from purchasing a product after seeing an offensive advertisement, etc.). In some examples, lift can be expressed as a relative increase (e.g., as a percentage, etc.) to a baseline value (e.g., the amount of sales as if there had been no advertising campaign, etc.). In other examples, lift can be expressed as an absolute value (e.g., a dollar amount, a number of products, etc.). In some examples, interested parties (e.g., advertisers, product manufacturers, etc.) can use lift to determine the effectiveness of an advertisement campaign, vehicle, etc.

In an advertising campaign that uses more than one vehicle (e.g., television and digital, etc.), determining the lifts corresponding to an individual vehicle can be difficult. As used herein, “component lift” refers to the lift associated with a single vehicle of the advertising campaign. A component lift is distinct from “measured lift.” The measured lift of a vehicle, as used herein, refers to the lift associated with consumers that were exposed to one or more advertisement(s) via that vehicle. For example, in an advertisement campaign with two vehicles (e.g., television and radio) each vehicle has an associated component lift and measured lift. In this example, the television measured lift is associated with any consumers who were exposed to a television advertisement and can include consumers who were exposed to both television and radio advertisements. On the other hand, the television component lift is the lift corresponding to only those consumers who were exposed to advertisements via the television vehicle. Similarly, radio measured lift is associated with any consumers that were exposed to a radio advertisement and can include consumers who were exposed to both radio advertisements and television advertisements.

In many examples, interested entities may only have measured lifts available because component lift can difficult and/or costly to measure directly. Further, in some examples, measured lifts can be difficult to interpret. For example, in a two vehicle advertising campaign in which both vehicles have positive measured lifts, it is possible for one of the vehicles to have a negative component lift (e.g., a campaign with both radio and television can have an overall positive lift but the television vehicle in isolation may have a negative effect on the campaign, etc.).

Determining the component lifts of an advertising campaign are important to an advertising entity such information facilitates the determination of the efficacy of advertising associated with a particular vehicle. Knowing the efficacy of a particular vehicle allows an advertising entity as to allocate campaign resources more efficiently and/or otherwise prevent the wasted allocation of resources (e.g., financial resources associated with air time purchases, computing resources to render ineffective media, etc.). For example, an advertising entity can determine that a particular vehicle is associated with a decline in lift and may reallocate budget resources (e.g., money, computing resources) to other more successful vehicles. Additionally or alternatively, an advertising entity may modify the advertisements associated with a vehicle with a low or negative component lift to increase their efficacy (e.g., changing the graphics associated with an online advertisement, etc.).

Methods and apparatus disclosed herein improve the technical field of advertising research by enabling the calculation of component lifts as distinguished from measured lifts. An example disclosed method includes segregating measured impression counts of an advertisement campaign into vehicles, determining measured lift associated with respective ones of the vehicles and establishing correlations between component lifts and the measured lifts, the correlations based on a weighted average of the component lifts. The example method further includes determining the component lifts and modifying campaign resource allocation based on the component lifts.

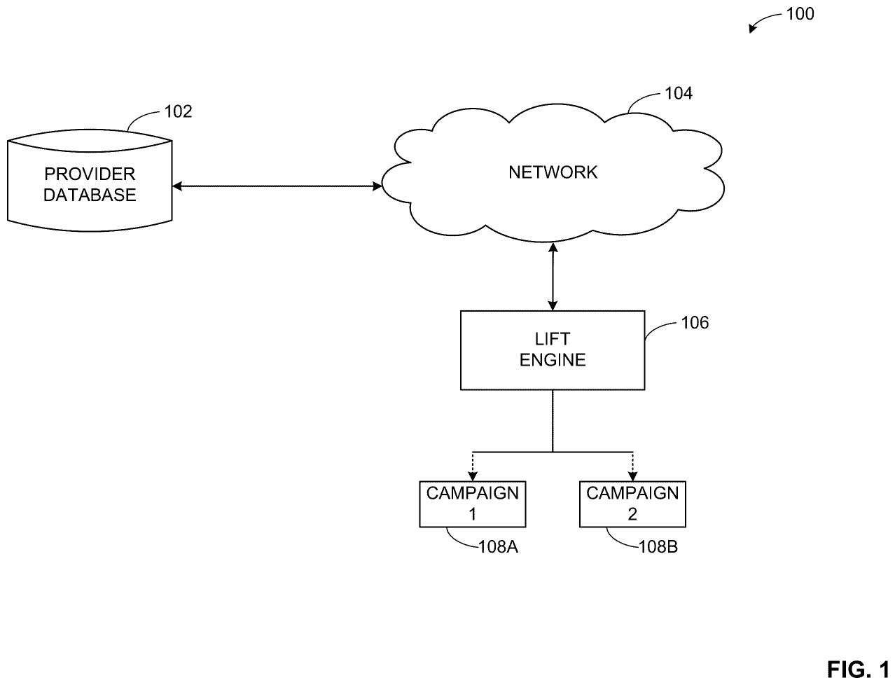

FIG. 1 is a schematic illustration of an example system 100 to calculate component lifts in accordance with the teachings of this disclosure. The example system 100 includes an example provider database 102, an example network 104 and an example lift engine 106. The example lift engine 106 can cause a change in the resource allocation of at least one of an example first campaign 108A and/or an example second campaign 108B. In some examples, the lift engine 106 selects and/or otherwise identifies one or more vehicles and/or campaigns 108A, 108B that exhibit a relatively highest metric indicative of lift. As such, the example lift engine 106 improves the technical field of data science advertising analysis and/or advertising research by preventing resource waste. Stated differently, the example lift engine 106 facilities identification and corresponding selection of the best advertising vehicle(s) and/or campaigns 108A, 108B.

The example provider database 102 is a database that contains data corresponding to advertisement impressions and measured lifts associated with respective vehicles. As used herein, an “impression count” is the number of people who viewed an advertisement on an associated vehicle at least once. In some examples, the lift engine 106 can request measured impression counts and measured lifts, via the network 104, from the example provider database 102. In some examples, the provider database 102 can be associated with a specific advertisement vehicle. For example, the provider database 102 can be associated with a television provider and provide measured impression counts and measured lifts to the lift engine 106 over the network 104. In some examples, the provider database 102 can be associated with the presentation media of the advertisement (e.g., a database of a social media website). In other examples, the provider database 102 is associated with the point of sale of the product (e.g., an online retailer, etc.). In some examples, the provider of the provider database 102 is provided an opportunity to log a respondent's impressions of an advertisement and provide information to the lift engine 106 if the respondent is a subscriber of services of the provider.

Although only a single provider database 102 is depicted in the illustrated example of FIG. 1, the lift engine 106 can retrieve information from any number of database providers (e.g., any number of databases, etc.). In some examples, the multiple providers are associated with a single vehicle (e.g., multiple social media website databases can be associated with the digital vehicle, etc.). In some examples, the provider database 102 provides a joint distribution of the measured impression counts and measured lifts to the lift engine 106. Additionally or alternatively, the lift engine 106 uses the transmitted data to calculate a joint distribution of the measured lifts and measured impression counts.

The example network 104 of FIG. 1 facilitates communication between the provider database 102 and the lift engine 106. As used herein “in communication,” including variants thereof, encompasses direct communication and/or indirect communication through one or more intermediary components. In some examples constant communication is not necessary such that selective communication at periodic, aperiodic, and/or scheduled intervals, as well as one-time events occurs. The example network 104 can be implemented by any suitable type of network (e.g., a cellular network, a wired network, the Internet, etc.). In some examples, the example network 104 can be absent (e.g., communication may occur via one or more busses, etc.). In these examples, the measured lifts and measured impression counts can be transmitted to the lift engine 106 by any other suitable method (e.g., physical mail, email, etc.).

The example lift engine 106 processes the retrieved measured lifts and measured impression counts to determine component lifts associated with each advertisement vehicle. In some examples, the lift engine 106 segregates the impression counts by vehicle type. In some examples, the lift engine 106 establishes correlations between the segregated measured lifts and the desired component lifts. In some examples, the lift engine 106 determines a weighted average correlation between the measured lifts and the component lifts. In other examples, any other appropriate correlation may be determined. The example lift engine 106 outputs the example component lift(s) and/or a selection of one or more vehicles that exhibit a relatively highest lift value. In some examples, the transmission of the component lifts 108 can causes a modification and/or selection of advertising campaign resource allocation.

The output of the example lift engine 106 can cause a change in the allocation of resources to at least of the first campaign 108A and/or the second campaign 108B. For example, the lift engine 106 can cause the budgetary and/or computing resources to be reallocated from one or more vehicles of the first advertising campaign 108A to one or more vehicles of the second advertising campaigns 108B. In some examples, the output of the lift engine can cause resources to be reallocated within the first advertising campaign 108A and/or second advertising campaign (e.g., reallocating resources from a less effective vehicle in the first advertising campaign 108A to a more effective vehicle of the first advertising campaign 108A, etc.) In some examples, the output of the lift engine 106 can cause a modification to an advertisement associated with at least one of the first advertising campaign 108A and/or the second advertising campaign 108B (e.g., the change in the graphic of an online advertisement, etc.).

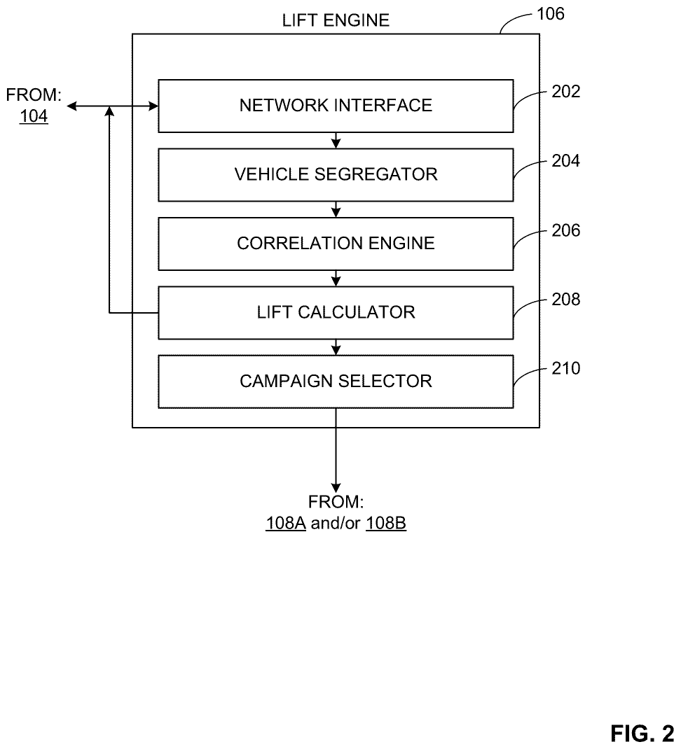

FIG. 2 is an example implementation of the lift engine 106 of FIG. 1. The example lift engine 106 includes an example network interface 202, an example vehicle segregator 204, an example correlation engine 206, an example lift calculator 208, and an example resource allocator interface 210. In the illustrated example of FIG. 2, the example network interface 202 is a means for communicating or a communicating means. In the illustrated example of FIG. 2, the example vehicle segregator 204 is a means for segregating, a means for vehicle segregating, a vehicle segregating means, or a segregating means. In the illustrated example of FIG. 2, the example correlation engine 206 is a means for establishing or an establishing means. In the illustrated example of FIG. 2, the example lift calculator 208 is a means for component lift determining or a determining means. In the illustrated example of FIG. 2, the example resource allocator interface 210 is a means for modifying or a modifying means. As used herein, the example means communicating, the example means for segregating, the example means for establishing, the example means for component lift determining, and the example means for modifying are hardware.

The example network interface 202 of FIG. 2 facilitates communication between the lift engine 106 and the provider database(s) 102 of FIG. 1. For example, the network interface 202 can transmit a request to retrieve measured lifts and/or measured impression counts from the provider database(s) 102. For example, the network interface 202 of FIG. 2 can request and/or otherwise retrieve measured impression counts and measured lifts associated with a first vehicle of an advertising campaign (e.g., television, etc.) and a second vehicle of an advertising campaign (e.g., digital, etc.). An example summary of the requested data is depicted below in Table 1:

TABLE 1
Retrieved Example Lift Information

| Platform | Measured Impressions | Measured Lift |
|---|---|---|
| All | n_{S} | L_{S} |
| Vehicle 1 | n_{1A} | L_{1A} |
| Vehicle 2 | n_{2A} | L_{2A} |

Where n_{S} represents a total measured impression count associated with all vehicles of interested (e.g., the first vehicle and the second vehicle), n_{1A} represents a measured impression count associated with any person who had an impression via a first vehicle, n_{2A} represents a measured impression count associated with any person who had an impression via a second vehicle, L_{S} is the total lift of the campaign, L_{1A} represents a measured lift associated with the first vehicle, and L_{2A} represents a measured lift associated with the second vehicle. In some examples, the network interface 202 retrieves data from the provider database(s) 102 (e.g., via the network 104). In some examples, the network interface 202 processes the retrieved data into a format readable by the example vehicle segregator 204. In some examples, in advertisement campaigns with more than two vehicles, the network interface 202 retrieves information about the joint distribution of measured impression count(s) and measured lift(s) of each vehicle. In some examples, the known measured lifts and known measured impression counts of Table (1) can be used to determine component lifts associated with each vehicle. In some examples, the measured lift data received by the example network interface 202 can be segregated into vehicle types by the vehicle segregator 204.

The example vehicle segregator 204 segregates the retrieved measured impression counts into component impression counts. An example matrix of component impression counts is depicted in example Table (2):

TABLE 2
Component Lift Vehicle Relationship matrix

| | Vehicle 1 | | |
|---|---|---|---|
| Vehicle 2 | Contributing | No | Yes |
| | Impression Counts? | | |
| | No | n₀₀ | n₁₀ |
| | Yes | n₀₁ | n₁₁ |

Where n₀₀ represents a component impression count associated with neither the first vehicle nor the second vehicle, n₁₀ represents a component impression count associated with respondents who had impressions only on the first vehicle, n₀₁ represents a component impression count associated with respondents who had impressions only on the second vehicle, n₁₁ represents a component impression count associated with both the first vehicle and the second vehicle. In some examples, the component impression counts n₀₀, n₁₀, n₀₁, and n₁₁ are mutually exclusive (e.g., there is no overlap between the component impression counts, etc.). The component impression counts may be calculated from the measured impression counts in a manner consistent with example Equations (1), (2) and (3):

$${n}_{10} = {n}_{S} - {n}_{1 A} \qquad ( 1 )$$

$${n}_{01} = {n}_{S} - {n}_{2 A} \qquad ( 2 )$$

$${n}_{11} = {n}_{2 A} + {n}_{1 A} - {n}_{S} \qquad ( 3 )$$

In other examples, the vehicle segregator 204 can use any other suitable equations or techniques to segregate the measured impression counts into component impression counts.

The example correlation engine 206 establishes correlations between the measured lifts and the desired component lifts. An example matrix of component lifts is depicted in Table (3):

TABLE 3
Component Lift Vehicle Relationship matrix

| | Vehicle 1 (V₁) | | |
|---|---|---|---|
| | Contributing Lift? | No | Yes |
| Vehicle 2 | No | L₀₀ | L₁₀ |
| (V₂) | Yes | L₀₁ | L₁₁ |

Where L₀₀ is the component lift associated with neither the first vehicle (e.g., V₁) nor the second vehicle (e.g., V₂), L₁₀ is the component lift associated with respondents who had impressions only via the first vehicle, L₀₁ is the component lift associated with respondents who had impressions only via the second vehicle and, L₁₁ is the component lift associated with both the first vehicle and the second vehicle. The example component lifts of table (3) are related to the measured lifts table (1). For example, the total measured lift (L_{S}) is related to the all of the component lifts (L₀₀, L₁₀, L₀₁, L₁₁). The measured lift associated with the first vehicle (L_{1A}) is associated with the component lifts associated with the first vehicle (L₁₀, L₁₁). Similarly, the measured lift associated with the second vehicle (L_{2A}) is associated with the component lifts associated with the second vehicle (L₀₁, L₁₁).

The example correlation engine 206 determines that the correlation (e.g., the mathematical relationship, etc.) between the measured lift(s) and the component lift(s) is an average of the component lift(s), weighted by corresponding impression counts (e.g., a weighted average, etc.). In this example, the correlation engine 206 determines the correlation between the measured total lift (L_{S}) and component lifts (L₀₀, L₀₁, L₁₀, L₁₁) based on a ratio of (A) a sum of impression counts multiplied by respective component lifts and (B) a sum of those impression counts, in a manner consistent example equation (4):

$${L}_{S} = \frac{{n}_{11} {L}_{11} + {n}_{0} {L}_{01} + {n}_{10} {L}_{10}}{{n}_{11} + {n}_{01} + {n}_{10}} - {L}_{00} \qquad ( 4 )$$

The example correlation engine 206 determines the correlation between the first vehicle measured lift (L_{1A}) and component lifts (L₀₀, L₁₀, L₁₁) to be:

$${L}_{1 A} = \frac{{n}_{11} {L}_{11} + {n}_{10} {L}_{10}}{{n}_{11} + {n}_{10}} - {L}_{00} \qquad ( 5 )$$

Similarly, the example correlation engine 206 determines the correlation between the second vehicle measured lift (L_{2A}) and the associated component lifts (L₀₀, L₀₁, L₁₁) to be:

$${L}_{2 A} = \frac{{n}_{11} {L}_{11} + {n}_{01} {L}_{01}}{{n}_{11} + {n}_{01}} - {L}_{00} \qquad ( 6 )$$

In example Equations (4), (5) and (6), each component lift (e.g., L₀₁, L₁₀, L₁₁), is weighed by the corresponding component impression counts (e.g., n₀₁, n₁₀, n₁₁, respectively). In other examples, the correlation engine 206 determines any other suitable correlation between the component lifts and measured lifts (e.g., weighted geometric mean, etc.). In some examples, the correlations determined by the correlation engine 206 are approximations and/or derived estimations. Additionally or alternatively, the correlations determined by the correlation engine 206 may be derived based on empirical data.

The example lift calculator 208 determines the component lifts based on the determined correlations. For example, in Equations (4), (5) and (6) there are four unknown component lifts (e.g., L₀₀, L₁₀, L₀₁, L₁₁). In some examples, the lift calculator 208 may set L₀₀ to be equal to zero which modifies Equations (4), (5) and (6) into:

$${L}_{S} = \frac{{n}_{11} {L}_{11} + {n}_{0} {L}_{01} + {n}_{10} {L}_{10}}{{n}_{11} + {n}_{01} + {n}_{10}} \qquad ( 7 )$$

$${L}_{1 A} = \frac{{n}_{11} {L}_{11} + {n}_{10} {L}_{10}}{{n}_{11} + {n}_{10}} \qquad ( 8 )$$

$${L}_{2 A} = \frac{{n}_{11} {L}_{11} + {n}_{01} {L}_{01}}{{n}_{11} + {n}_{01}} \qquad ( 9 )$$

In some examples, L₀₀ is assumed to be zero as the lift associated with no advertisement vehicle is not desired by interested parties (e.g., advertisers, product manufacturers, etc.). Additionally or alternatively, associating L₀₀ with a value of zero allows the other component lifts (e.g., L₁₀, L₀₁, L₁₁) to be determined relative to a baseline lift (e.g., L₀₀). In this example, the lift calculator 208 can use Equations (7), (8) and (9) to determine the three remaining component lifts (e.g., L₁₀, L₀₁, L₁₁). In other examples, the lift calculator 208 utilizes any suitable numerical method to determine the component lifts (e.g., entropy optimization, least squares, etc.).

While the operations of the example network interface 202, the example vehicle segregator 204, correlation engine 206 and the example lift calculator 208 are described with reference to an advertising campaign using two vehicles, an advertising campaign including any number of vehicles may be analyzed. For example, given an advertisement campaign including three vehicles (e.g., television, radio, digital, etc.) the network interface 202 requests four measured lifts (e.g., vehicle one any, vehicle two any, vehicle three any and overall campaign) from the provider database 102. In this example, the vehicle segregator 204 segregates the retrieved impression counts into component impression counts associated with each of the three vehicles. In this example, the correlation engine 206 determines correlations between the four retrieved measured lifts (e.g., vehicle one any, vehicle two any, vehicle three any and overall campaign) and the desired component lifts (e.g., vehicle one only, vehicle two only, vehicle three only, overall campaign, etc.). In some examples, the lift calculator 208 solves for the component lifts using a numerical method (e.g., entropy optimization, orthogonal decomposition, any numerical method suitable for solving a constrained least squares problem, etc.).

The example campaign selector 210 uses the determined component lifts to modify the allocation of campaign resources (e.g., budget resources, computing resources, etc.). For example, the campaign selector 210 reallocates the resources from a less productive vehicle to a more productive vehicle. In some examples, the campaign selector 210 changes a budget associated with one or more vehicles types of the advertising campaign. In other examples, the campaign selector 210 issues a notification to an analyst indicating that a particular vehicle is unproductive so that analyst and/or the campaign selector 210 can change the content of the advertisement on that vehicle. In other examples, campaign selector 210 can take any suitable action to modify the resource allocation of the advertising campaign.

While an example manner of implementing the example lift engine 106 of FIGS. 1 and 2 is illustrated in FIG. 2, one or more of the elements, processes and/or devices illustrated in FIG. 2 may be combined, divided, re-arranged, omitted, eliminated and/or implemented in any other way. Further, the example network interface 202, the example vehicle segregator 204, the example correlation engine 206, the example lift calculator 208, the example campaign selector 210 and/or, more generally, the example lift engine 106 of FIG. 2 may be implemented by hardware, software, firmware and/or any combination of hardware, software and/or firmware. Thus, for example, any of the example network interface 202, the example vehicle segregator 204, the example correlation engine 206, the example lift calculator 208, the example campaign selector 210 and/or, more generally, the example lift engine 106 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, network interface 202, the example vehicle segregator 204, the example correlation engine 206, the example lift calculator 208, the example campaign selector 210 is/are hereby expressly defined to include a non-transitory computer readable storage device or storage disk such as a memory, a digital versatile disk (DVD), a compact disk (CD), a Blu-ray disk, etc. including the software and/or firmware. Further still, the example lift engine 106 of FIGS. 1 and 2 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

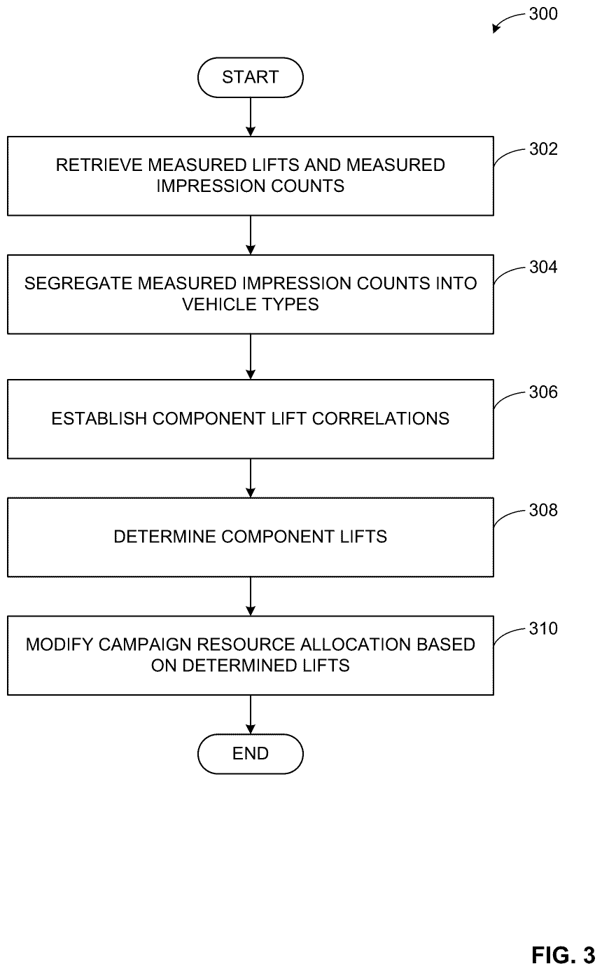

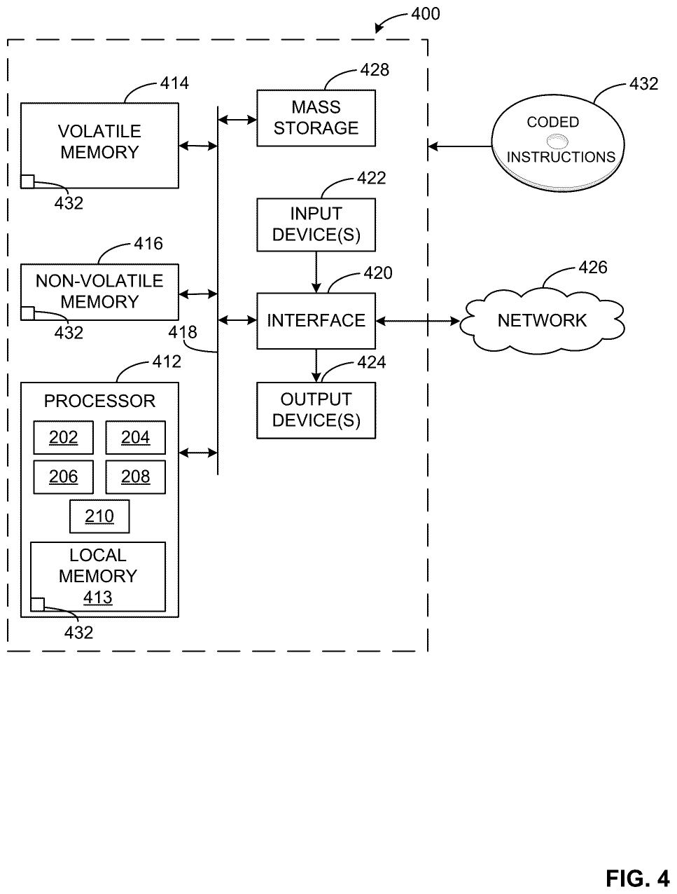

A flowchart representative of example hardware logic, machine readable instructions, hardware implemented state machines, and/or any combination thereof for implementing the lift engine 106 of FIGS. 1 and/or 2 is shown in FIG. 3. The machine readable instructions may be an executable program or portion of an executable program for execution by a computer processor such as the processor 412 shown in the example processor platform 400 discussed below in connection with FIG. 4. The program may be embodied in software stored on a non-transitory computer readable storage medium such as a CD-ROM, a floppy disk, a hard drive, a DVD, a Blu-ray disk, or a memory associated with the processor 412, but the entire program and/or parts thereof could alternatively be executed by a device other than the processor 412 and/or embodied in firmware or dedicated hardware. Further, although the example program is described with reference to the flowchart illustrated in FIG. 3, many other methods of implementing the example lift engine 106 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIG. 3 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

The program 300 of FIG. 3 begins at block 302. At block 302, the network interface 202 retrieves measured lifts and measured impression counts. For example, the network interface 202 sends a request to one or more databases (e.g., the provider database 102 of FIG. 1). to retrieve the measured lifts or impression counts over a network (e.g., network 104). In some examples, the network interface 202 converts the retrieved information into a format readable by the lift engine 106. In some examples, the requested data is retrieved as a joint distribution. Alternatively, the data is retrieved by the network interface 202 by any other suitable means (e.g., manually entered by a respondent and/or analyst, accessed from a local memory (e.g., the memory 428 of FIG. 4), etc.).

At block 304, the vehicle segregator 204 segregates the impression counts into component impression counts. For example, in a two vehicle advertising campaign, the vehicle segregator 204 segregates the retrieved impression counts into the values described in example Table (2). In some examples, the vehicle segregator 204 employs example Equations (1)-(3) to segregate the measured impression counts into component impression count. In other examples, the vehicle segregator 204 uses any other suitable method to segregate the retrieved impression data into vehicle types. In some examples, the vehicle segregator 204 can segregate measured lift values associated with the impression counts into vehicle types.

At block 306, the correlation engine 206 establishes component lift correlations. For example, the correlation engine 206 determines (e.g., calculates, derives, etc.) the correlation between the measured lifts and the component lifts to be a weighted average. In this example, the correlation engine 206 establishes the correlations in a manner consistent with Equations (4)-(6). In other examples, the correlation engine 206 uses any other suitable correlation between measured lifts and the component lifts. In some examples, the lift calculator 208 uses a numerical method to calculate the component lift(s).

At block 308, the lift calculator 208 determines the component lifts. For example, in a two vehicle advertising campaign, the lift calculator 208 employs the example Equations (7)-(9) to determine the component lifts. In some examples, the lift calculator 208 makes any suitable assumptions to determine the component lifts. For example, the lift calculator assumes that the baseline lift (e.g., L₀₀, etc.) is equal to zero.

At block 310, the campaign selector 210 modifies campaign resource allocation based on the determined lift. For example, the campaign selector 210 allocates the resources (e.g., funding, processing resources, bandwidth, etc.) from a less productive vehicle (e.g., a vehicle with a relatively low component lift) to a more productive vehicle (e.g., a vehicle with a relatively high component lift). In some examples, the campaign selector 210 issues a notification to an analyst indicating that a particular vehicle is unproductive so that the analyst changes the content of the advertisement associated with that vehicle. The process 300 then ends.

FIG. 4 is a block diagram of an example processor platform 400 structured to execute the instructions of FIG. 3 to implement the lift engine 106 of FIGS. 1 and 2. The processor platform 400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 400 of the illustrated example includes a processor 412. The processor 412 of the illustrated example is hardware. For example, the processor 412 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements network interface 202, the example vehicle segregator 204, the example correlation engine 206, the example lift calculator 208 and the example campaign selector 210.

The processor 412 of the illustrated example includes a local memory 413 (e.g., a cache). The processor 412 of the illustrated example is in communication with a main memory including a volatile memory 414 and a non-volatile memory 416 via a bus 418. The volatile memory 414 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 416 may be implemented by flash memory and/or any other desired type of memory device. Access to the main memory 414, 416 is controlled by a memory controller.

The processor platform 400 of the illustrated example also includes an interface circuit 420. The interface circuit 420 may be implemented by any type of interface standard, such as an Ethernet interface, a universal serial bus (USB), a Bluetooth® interface, a near field communication (NFC) interface, and/or a PCI express interface.

In the illustrated example, one or more input devices 422 are connected to the interface circuit 420. The input device(s) 422 permit(s) a user to enter data and/or commands into the processor 412. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 424 are also connected to the interface circuit 420 of the illustrated example. The output devices 424 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 420 of the illustrated example, thus, typically includes a graphics driver card, a graphics driver chip and/or a graphics driver processor.

The interface circuit 420 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 426. The communication can be via, for example, an Ethernet connection, a digital subscriber line (DSL) connection, a telephone line connection, a coaxial cable system, a satellite system, a line-of-site wireless system, a cellular telephone system, etc.

The processor platform 400 of the illustrated example also includes one or more mass storage devices 428 for storing software and/or data. Examples of such mass storage devices 428 include floppy disk drives, hard drive disks, compact disk drives, Blu-ray disk drives, redundant array of independent disks (RAID) systems, and digital versatile disk (DVD) drives.

The machine executable instructions 300 of FIG. 3 may be stored in the mass storage device 428, in the volatile memory 414, in the non-volatile memory 416, and/or on a removable non-transitory computer readable storage medium such as a CD or DVD.

From the foregoing, it will be appreciated that example methods, apparatus and articles of manufacture have been disclosed that determine component lifts and synergy from overlapping effects. The disclosed methods and apparatus improve the efficiency of using a computing device by allowing resources of an adverting campaign (e.g., processing power, user time, money, etc.) to be more efficiently allocated and/or otherwise allocated in a manner that reduces waste (e.g., computational waste of rendering advertising vehicles having relatively poor performance, reducing monetary waste of such advertising vehicles, etc.). Further, the disclosed methods and apparatus allow the productivity of individual vehicles to be determined. The disclosed methods and apparatus are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An audience measurement computing system comprising:
a processor;
a memory having stored therein computer readable instructions that, when executed by the processor, cause the audience measurement computing system to perform operations comprising:
accessing, via network communications with one or more servers, measured impression counts associated with an advertising campaign, wherein the accessed measured impression counts indicate: (i) a measured total impression count of the advertising campaign for impressions delivered through both a television delivery vehicle and a digital delivery vehicle collectively, (ii) a measured television impression count for any impressions of the advertising campaign delivered through the television delivery vehicle, and (iii) a measured digital impression count for any impressions of the advertising campaign delivered through the digital delivery vehicle;
accessing, via network communications with one or more servers, measured lift values associated with the advertising campaign, wherein the measured lift values indicate: (i) a measured total lift value of the advertising campaign attributed to impressions delivered through both the television delivery vehicle and the digital delivery vehicle collectively, (ii) a measured television lift value attributed to any impressions of the advertising campaign delivered through the television delivery vehicle, and (iii) a measured digital lift value attributed to any impressions of the advertising campaign delivered through the digital delivery vehicle;
based on differences between the measured total impression count and the measured television impression count and the measured digital impression count, segregating the measured impression counts into mutually exclusive impression counts including: (i) impressions associated with both the television delivery vehicle and the digital delivery vehicle, (ii) impressions associated solely with the television delivery vehicle, and (iii) impressions associated solely with the digital delivery vehicle;
determining vehicle-specific lift components indicative of: (i) a first extent of lift of the advertising campaign attributable solely to the television delivery vehicle, and (ii) a second extent of lift of the advertising campaign attributable solely to the digital delivery vehicle, wherein the determining the vehicle-specific lift components is based on the mutually exclusive impression counts and respective definitions of the measured lift values according to correlations with the vehicle-specific lift components weighted according to the mutually exclusive impression counts; and
generating a report indicating the vehicle-specific lift components.

2. The audience measurement computing system of claim 1, wherein the operations further include determining a modification to resource allocation between the television delivery vehicle and the digital delivery vehicle based on the vehicle-specific lift components.

3. The audience measurement computing system of claim 2, wherein the operations further include:
suggesting the modification to resource allocation; and
responsive to receiving an indication that the suggested modification to resource allocation has been approved, causing the advertising campaign to be modified in accordance with the modification.

4. The audience measurement computing system of claim 1, wherein the vehicle-specific lift components are determined relative to a baseline lift value.

5. The audience measurement computing system of claim 1, wherein the advertising campaign includes impressions delivered through the television delivery vehicle that overlap with impressions delivered through the digital delivery vehicle.

6. The audience measurement computing system of claim 1, wherein the respective definitions of the measured lift values are defined by three constrained equations which define each of the measured lift values according to respective weighted combinations of the vehicle-specific lift components.

7. The audience measurement computing system of claim 6, wherein the determining the vehicle-specific lift components includes using a numerical method to solve for the vehicle-specific lift components based on the three constrained equations.

8. A computer-implemented method comprising:
accessing, via network communications with one or more servers, measured impression counts associated with an advertising campaign, wherein the accessed measured impression counts indicate: (i) a measured total impression count of the advertising campaign for impressions delivered through both a television delivery vehicle and a digital delivery vehicle collectively, (ii) a measured television impression count for any impressions of the advertising campaign delivered through the television delivery vehicle, and (iii) a measured digital impression count for any impressions of the advertising campaign delivered through the digital delivery vehicle;
accessing, via network communications with one or more servers, measured lift values associated with the advertising campaign, wherein the measured lift values indicate: (i) a measured total lift value of the advertising campaign attributed to impressions delivered through both the television delivery vehicle and the digital delivery vehicle collectively, (ii) a measured television lift value attributed to any impressions of the advertising campaign delivered through the television delivery vehicle, and (iii) a measured digital lift value attributed to any impressions of the advertising campaign delivered through the digital delivery vehicle;
based on differences between the measured total impression count and the measured television impression count and the measured digital impression count, segregating the measured impression counts into mutually exclusive impression counts including: (i) impressions associated with both the television delivery vehicle and the digital delivery vehicle, (ii) impressions associated solely with the television delivery vehicle, and (iii) impressions associated solely with the digital delivery vehicle;
determining vehicle-specific lift components indicative of: (i) a first extent of lift of the advertising campaign attributable solely to the television delivery vehicle, and (ii) a second extent of lift of the advertising campaign attributable solely to the digital delivery vehicle, wherein the determining the vehicle-specific lift components is based on the mutually exclusive impression counts and respective definitions of the measured lift values according to correlations with the vehicle-specific lift components weighted according to the mutually exclusive impression counts; and
generating a report indicating the vehicle-specific lift components.

9. The computer-implemented method of claim 8, further including determining a modification to resource allocation between the television delivery vehicle and the digital delivery vehicle based on the vehicle-specific lift components.

10. The computer-implemented method of claim 9, further including:
suggesting the modification to resource allocation; and
responsive to receiving an indication that the suggested modification to resource allocation has been approved, causing the advertising campaign to be modified in accordance with the modification.

11. The computer-implemented method of claim 8, wherein the vehicle-specific lift components are determined relative to a baseline lift value.

12. The computer-implemented method of claim 8, wherein the advertising campaign includes impressions delivered through the television delivery vehicle that overlap with impressions delivered through the digital delivery vehicle.

13. The computer-implemented method of claim 8, wherein the respective definitions of the measured lift values are defined by three constrained equations which define each of the measured lift values according to respective weighted combinations of the vehicle-specific lift components.

14. The computer-implemented method of claim 13, wherein the determining the vehicle-specific lift components includes using a numerical method to solve for the vehicle-specific lift components based on the three constrained equations.

15. A non-transitory computer readable medium having stored thereon machine readable instructions that, when executed by a processor of a computing system, cause performance of operations comprising:
accessing, via network communications with one or more servers, measured impression counts associated with an advertising campaign, wherein the accessed measured impression counts indicate: (i) a measured total impression count of the advertising campaign for impressions delivered through both a television delivery vehicle and a digital delivery vehicle collectively, (ii) a measured television impression count for any impressions of the advertising campaign delivered through the television delivery vehicle, and (iii) a measured digital impression count for any impressions of the advertising campaign delivered through the digital delivery vehicle;
accessing, via network communications with one or more servers, measured lift values associated with the advertising campaign, wherein the measured lift values indicate: (i) a measured total lift value of the advertising campaign attributed to impressions delivered through both the television delivery vehicle and the digital delivery vehicle collectively, (ii) a measured television lift value attributed to any impressions of the advertising campaign delivered through the television delivery vehicle, and (iii) a measured digital lift value attributed to any impressions of the advertising campaign delivered through the digital delivery vehicle;
based on differences between the measured total impression count and the measured television impression count and the measured digital impression count, segregating the measured impression counts into mutually exclusive impression counts including: (i) impressions associated with both the television delivery vehicle and the digital delivery vehicle, (ii) impressions associated solely with the television delivery vehicle, and (iii) impressions associated solely with the digital delivery vehicle;
determining vehicle-specific lift components indicative of: (i) a first extent of lift of the advertising campaign attributable solely to the television delivery vehicle, and (ii) a second extent of lift of the advertising campaign attributable solely to the digital delivery vehicle, wherein the determining the vehicle-specific lift components is based on the mutually exclusive impression counts and respective definitions of the measured lift values according to correlations with the vehicle-specific lift components weighted according to the mutually exclusive impression counts; and
generating a report indicating the vehicle-specific lift components.

16. The non-transitory computer readable medium of claim 15, wherein the operations further include determining a modification to resource allocation between the television delivery vehicle and the digital delivery vehicle based on the vehicle-specific lift components.

17. The non-transitory computer readable medium of claim 16, wherein the operations further include:
suggesting the modification to resource allocation; and
responsive to receiving an indication that the suggested modification to resource allocation has been approved, causing the advertising campaign to be modified in accordance with the modification.

18. The non-transitory computer readable medium of claim 15, wherein the advertising campaign includes impressions delivered through the television delivery vehicle that overlap with impressions delivered through the digital delivery vehicle.

19. The non-transitory computer readable medium of claim 15, wherein the respective definitions of the measured lift values are defined by three constrained equations which define each of the measured lift values according to respective weighted combinations of the vehicle-specific lift components.

20. The non-transitory computer readable medium of claim 19, wherein the determining the vehicle-specific lift components includes using a numerical method to solve for the vehicle-specific lift components based on the three constrained equations.
